(19) United States
(12) Patent Application Publication
(10) Pub. No.: US 2021/0387488 A1
(43) Pub. Date: Dec. 16, 2021

(54) DEVICE FOR SELF-EXTRACTION OF VEHICLE USING A TOWING ROPE

(71) Applicant: Sergei Evgen'evich ZAIKA, Saint-Petersburg (RU)

(72) Inventor: Sergei Evgen'evich ZAIKA, Saint-Petersburg (RU)

(21) Appl. No.: 17/279,505

(22) PCT Filed: Oct. 31, 2019
(86) PCT No.: PCT/RU2019/000777

§ 371 Date: Mar. 24, 2021

(30) Foreign Application Priority Data
May 17, 2019 (RU) 2019115198

(51) Int. Cl. B60C 27/06

(52) U.S. Cl. CPC B60C 27/068; B60C 27/065

(57) ABSTRACT

A device for self-extraction of a vehicle using a towing rope made in the form of a gripper, including at least three arms arranged circumferentially and having a shape that allows installation on the drive wheel of the vehicle. The device has a traverse with a threaded opening in the center where the threaded rod is installed, at the end of the rod facing the vehicle wheel in the operating position, a hub stop heel is installed. The gripper's arms have two L-shaped parts, the first parts with their side that is oriented along the axis of the device are pivotally installed on the traverse, and the second parts are rigidly connected to the first parts at a section of their sides oriented in the radial direction from the axis of the device.

### FIELD OF THE INVENTION

The present invention relates to the field of road transport, and in particular to devices for self-extraction of a vehicle when slipping. The invention can also be used in the field of armed forces.

### BACKGROUND OF THE INVENTION

A device for self-extraction of a vehicle is known (utility model RU7960U1). A device for self-extraction of a vehicle containing a drum with a winded cable, characterized in that the drum is configured to be installed on the drive wheel hub of the vehicle, while at least one of its sides is provided with openings for fasteners. The openings on the sides of the drum have a shape of a drop.

The main drawback is the necessity to change the design of the vehicle, the installation of non-standard equipment since it is necessary to put the drum before the trip (the wheels should be fixed through the drum and disk to the hub by means of long non-standard bolts).

Known is a counter-tapping device (patent for the invention RU2023598C1), containing levers fixed to the carrier hub, their free ends have cleats and bent in order to cover the tire tread, and a device for pressing the levers to the tread made in the form of a pressure hub installed coaxially with the bearing hub and connected with it by means of a coupling bolt, characterized in that the pressure hub is made with a pressure ring having guide elements through which levers are passed being able of radial displacement. The device is designed to be installed on car wheels when driving on an icy and snowy road in winter, on a dirt road during the spring mud season, summer and autumn rains.

Mainly present anti-slip devices merely able to exclude the slipping of the wheels of the vehicle. The known technical solutions do not provide using the wheel torque and convert it into the translational movement of the vehicle (winch principle).

The closest technical solution chosen as a closest prior art is an anchor hook being a part of the device for self-extraction of a wheel type tractor (patent RU2597332C2). The device comprises a tow-spring mechanism having a towing rope installed in the towing device of the front part of the tractor and locked at the end of the coil spring, a towing rope installed and locked between the ends of the coil springs, and a towing rope installed between the ends of the coil spring and the anchor hook, containing shaped hooks and a reverse lock designated for its installation in the technological openings of the drive wheel disc.

The main disadvantage of the anchor hook is the insufficient reliability of fixation and the design complexity.

### SUMMARY OF THE INVENTION

Technical effect of the invention is increasing device reliability during operating simultaneously providing increase in the technological ability and design simplification, also providing its being collapsible for possibility of storage and transport in a compact case.

The technical effect is obtained due to the claimed device for self-extraction of the vehicle using a towing rope made in the form of a gripper, including at least three arms arranged circumferentially and having a shape that allows installation on the drive wheel of the vehicle,

characterized in that

has a traverse with a threaded opening in the center where the threaded rod is installed,

at the end of the rod facing the vehicle wheel in the operating position, a hub stop heel is installed,

the gripper's arms have two L-shaped parts,

the first parts with their side that is oriented along the axis of the device are pivotally installed on the traverse adapted to swing in planes passing through the axis of the device coinciding with the axis of the rod, and have free ends,

the second parts are rigidly connected to the first parts at a section of their sides oriented in the radial direction from the axis of the device, adapted to adjust the positions of the second parts in the radial direction in accordance with the radius of the wheel of the vehicle,

the second parts of the arms at the ends of their sections oriented along the axis of the device and designed to fix the device on the wheel in the radial direction contain grippers which together with the hub stop that is pressed against the area of the wheel hub by a threaded rod, provide fixing the device on the wheel in the axial direction,

the device contains a spacer element installed on the free end of the rod and adapted to longitudinal movement along it,

a threaded nut is also installed on the rod that provides clamping the spacer element towards the traverse,

the relative position, size and shape of the free ends of the arms, the traverse and spacer element provide bringing together the grippers of the arms in the radial direction and fixing the device to the wheel when sliding along the free ends of the arms of the spacer element, when it is moved towards the traverse when tightening the nut,

the device in the operating position provides fixing the free end of the towing cable to the device and winding the cable on the outer surface of the arms during rotation of the wheel with simultaneous self-extraction of the vehicle.

The grippers at the ends of the second parts of the arms have the shape of curved plates circumventing the vehicle wheel in the operating position.

The grippers are provided with cleats on the outside, the cleats having the shape of protrusions in the radial direction.

The spacer element have the shape of a plate with slots for the free ends of the arms.

The first parts of the arms have a T-shaped profile, oriented so that its wall facing the axis of the device.

The gripper of the device includes four arms.

The gripper of the device includes five arms.

The device is designed being collapsible.

### BRIEF DESCRIPTION OF THE DRAWINGS

The subject-matter of the present invention will now be described with reference to the accompanying drawings, in which:

FIG. 1 shows the main view of the device;

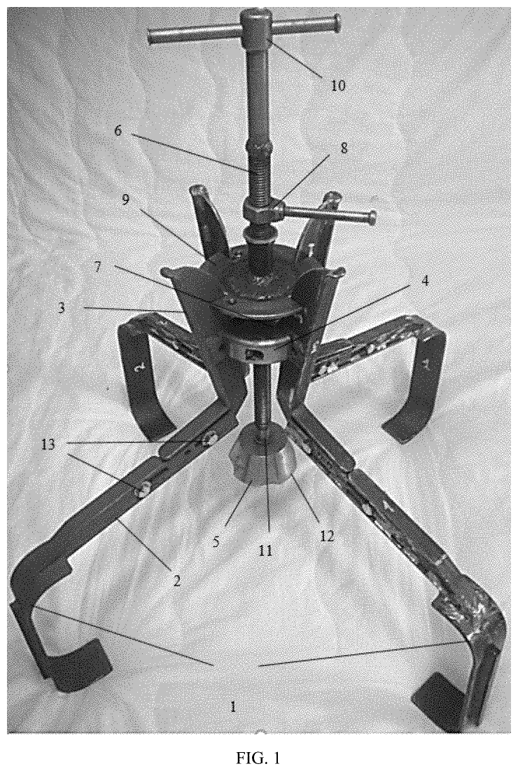

FIG. 2 shows the device in the operating position;

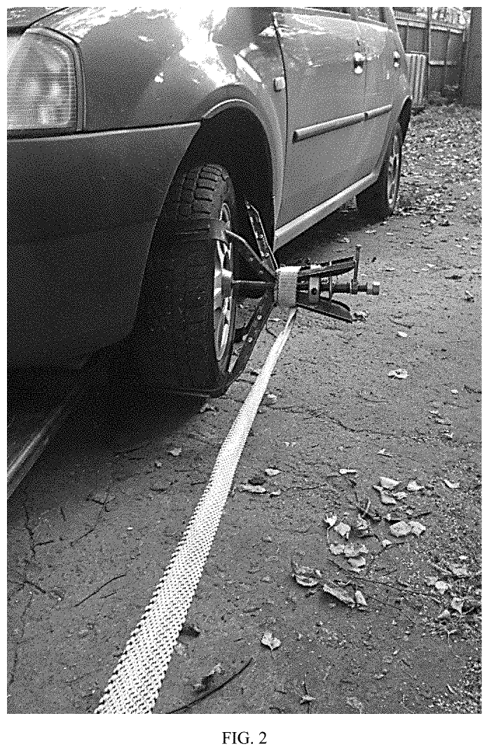

FIG. 3 shows the decomposed view of the device.

### DETAILED DESCRIPTION OF THE DRAWINGS

The drawings have the following positions: a gripper—1; arms—(on the presented figures a particular example is shown—4 pcs.), each consisting of the first part (horizontal half-arms)—3; and the second part (radial half-arms)—2; gripper arms traverse—4 with a threaded opening in the center where the threaded rod is installed; a hub stop heel—5 (the heel rotates on the rod, fixed with a nut inside the heel); threaded rod of an axial hub stop—6; bellevile spring of a radial spacer element—7; arm radial clamp nut—8; radial spacer element (in a particular example—plate)—9; head of an axial hub stop—10; installing the nut of the floating heel of the axial hub stop—11; rubber ring of an axial hub stop—12; adjusting openings of the gripper's arms depending on (R) the radius of the wheel—13.

Constructively, the arms are made so that when winding the tiring rope, the tiring rope additionally clamps (or tightens) the gripper.

The proposed device is adjustable for different wheel radii: fasteners for the first opening R-14-16; second opening R-17-19; third opening is R-20-21.

When using the device for self-extraction on freight vehicles, special vehicles, military tractors, etc. five arms can be installed for a better grip, in this case the traverse also able to have five arms installed on it. In this case, the shape of the traverse should be changed to the pentagon, and the principle of installation of the arms to the traverse remains the same. Increased is the thickness of the device's metal for heavy freight vehicles.

The device operates as follows. The device is a mechanical gripper for the drive wheel of the car (which slips if the car is stuck in the mud, snow, etc. “off-road”—the car does not move, the differential is actuating).

The desired radius 13 of the wheel should be set. The arms of the device for self-extraction have openings for the desired (R) radius of the wheel.

Feet are adjustable in radius R 14-15; 16-17; 18-19.

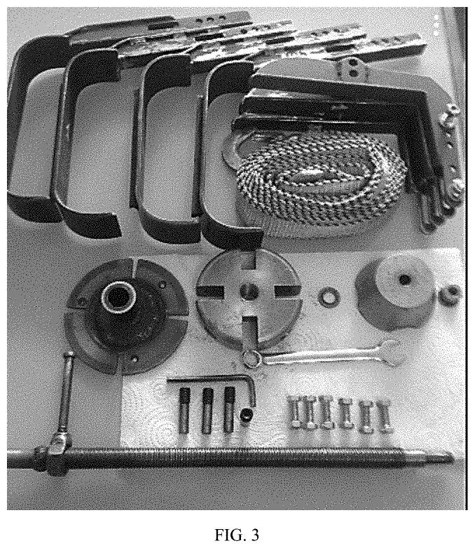

Two adjacent radial half-arms 2 are fixed to the horizontal half-arms 3 with bolts (FIG. 3). The remaining two arms are not fixed.

Two fixed arms should be put at the bottom of the wheel arches. Two not fixed arms (upper arms) should be put between the upper part of the wheel and the arch. The upper half-arms should be fixed.

All four arms are put on the tire cover at four radial points (crosswise).

The fifth point is the axial stop in the wheel hub.

The radial “slack” of the arms should be chosen by means of the arm radial clamp nut 8 so that the grippers 1 set tightly and fit the tire cover. Then, the axial slack should be chosen by means of the head of an axial hub stop 10 so that the device for self-extraction can be reliably fixed to the wheel.

Thus, a device for self-extraction can be fixed to the wheel at five points: four radial points and one axial point.

After fixing the device for self-extraction to the wheel one end of the towing rope/belt should be wound round two-three turns contrariwise the rotation of the wheel (towards the side of the intended exit).

The second end should be tightly tied to a tree, post, etc. or using a towing plow.

It should be the low gear chosen and it is possible to start slow moving. The towing belt is wound round the arms thereby actuating the action of the winch (the rotational movement of the device on the wheel is converted into traction and movement of the car).

If two devices for self-extraction of the vehicle is installed on the axial drive wheels, the towing cables/belts are fastened to top of the car, then the front or rear part of the car can be raised (depending on the type of drive).

Removing the device for self-extraction of the vehicle:

1. Ease off the nuts 8 and 10.

2. Retract the arms, remove the device for self-extraction.

3. Set the device for self-extraction of the vehicle in the initial position by repeating actions in the reverse order.

The claimed device is quick removable. It helps to avoid a necessity to install the electrical winch to the vehicle. The appearance of the vehicle remains without undesirable changes. Even frameless and non-all-wheel drive vehicle is able to keep off-road driving. It provides the compliance with the law on “changes in vehicle designs” (in the case of installing of non-standard equipment), in this case, an increase in axial wheel size.

1. A device for self-extraction of a vehicle using a towing rope made in the form of a gripper, including at least three arms arranged circumferentially and having a shape that allows installation on the drive wheel of the vehicle, wherein
the device has a traverse with a threaded opening in the center where the threaded rod is installed,
at the end of the rod facing the vehicle wheel in the operating position, a hub stop heel is installed,
the gripper's arms have two L-shaped parts,
the first parts with their side that is oriented along the axis of the device are pivotally installed on the traverse adapted to swing in planes passing through the axis of the device coinciding with the axis of the rod, and have free ends,
the second parts are rigidly connected to the first parts at a section of their sides oriented in the radial direction from the axis of the device, adapted to adjust the positions of the second parts in the radial direction in accordance with the radius of the wheel of the vehicle,
the second parts of the arms at the ends of their sections oriented along the axis of the device and designed to fix the device on the wheel in the radial direction contain grippers which together with the hub stop that is pressed against the area of the wheel hub by a threaded rod, provide fixing the device on the wheel in the axial direction,
the device contains a spacer element installed on the free end of the rod and adapted to longitudinal movement along it,
a threaded nut is also installed on the rod that provides clamping the spacer element towards the traverse,
the relative position, size and shape of the free ends of the arms, the traverse and spacer element provide bringing together the grippers of the arms in the radial direction and fixing the device to the wheel when sliding along the free ends of the arms of the spacer element, when it is moved towards the traverse when tightening the nut, and
the device in the operating position provides fixing the free end of the towing cable to the device and winding the cable on the outer surface of the arms during rotation of the wheel with simultaneous self-extraction of the vehicle.

2. The device according to claim 1, wherein
the grippers at the ends of the second parts of the arms have the shape of curved plates circumventing the vehicle wheel in the operating position.

3. The device according to claim 1, wherein
the grippers are provided with cleats on the outside, the cleats having the shape of protrusions in the radial direction.

4. The device according to claim 1, wherein
the spacer element have the shape of a plate with slots for the free ends of the arms.

5. The device according to claim 1 wherein
the first parts of the arms have a T-shaped profile, oriented so that its wall facing the axis of the device.

6. The device according to claim 1, wherein
the gripper of the device includes four arms.

7. The device according to claim 1, wherein
the gripper of the device includes five arms.

8. The device according to claim 1, wherein
the device is designed being collapsible.
